(19) United States
(12) Patent Application Publication
(10) Pub. No.: US 2009/0226018 A1
(43) Pub. Date: Sep. 10, 2009

(54) MICRO-TRANSDUCER WITH IMPROVED PERCEIVED SOUND QUALITY

(76) Inventors: Karsten Nielsen, Helsingor (DK); Lars Brandt Rosendahl Hansen, Soro (DK)

Correspondence Address: STITES & HARBISON PLLC, 1199 NORTH FAIRFAX STREET, SUITE 900, ALEXANDRIA, VA, 22314, US

(21) Appl. No.: 12/279,453

(22) PCT Filed: Feb. 16, 2007
(86) PCT No.: PCT/IB07/00374

§ 371 Date: Jan. 5, 2009

(30) Foreign Application Priority Data
Feb. 16, 2006 (DK) PA 2006 00223

(51) Int. Cl. H04R 1/20; H04R 9/06

(52) U.S. Cl. 381/337; 381/398

(57) ABSTRACT

The typical micro-transducer dedicated for mobile phones and headphones produces at high output in small back enclosure significant distortion in the acoustical output. These typical micro-transducers are designed for very high sensitivity and their mechanical suspension compliances are designed for worst case scenario, free air environment or a very large back enclosure (were the air stiffness from the back enclosure is much lower than the mechanical transducer suspension stiffness). This leads to poor low frequency response, high distortion, non-linear SPL characteristic and unnecessary high system resonance fre-quency when the transducer is placed in a small back enclosure. The Soft Suspension Long throw (SSL) micro-transducer has been designed with an improved non-circular shaped magnetic system, a low density/high Young's modulus thermal conducting diaphragm, a large-area non-circularly shaped diaphragm area, a non-circular shaped voice coil and a soft long-throw suspension which has been designed so that the SSL micro-transducer only functions properly when mounted in a small back enclosure. The combination of these inventions leads to a transducer architecture offering significant improvements in overall distortion, high RMS power handling, extended bass reproduction, also in compact volumes, and an overall flat frequency response. The combined result of several inventions is a significant overall improvement in perceived sound quality.

### TECHNICAL FIELD

The present invention relates generally to methods and products for use in optimising the qualitative attributes of a small sound system, such as a mobile phone or head phone, and more specifically to the design of micro sound emitting transducers, such as loudspeakers, aiming at optimising qualitative attributes of such transducers. The invention also relates to audio devices provided with such transducers and to a method for optimising acoustical performance (for instance sound quality) of such devices.

### BACKGROUND OF THE INVENTION

Micro-speakers are used widely in mobile phones today for audio reproduction, hands free speech, etc. Besides the desire for a high sound pressure level, there is an increasing demand for high quality audio reproduction.

The typical micro-transducer architecture is illustrated in FIG. 1. An oval type is shown for reference; however a range of alternatives exists (round, square, etc.), and such micro-transducers can furthermore be of various sizes.

The typical prior art micro-transducer is characterised by a thin combined plastic diaphragm and suspension, offering low weight to obtain high sensitivity. Furthermore, the typical micro-transducer is characterised by a diaphragm area that is relatively small compared with the total transducer area. Finally, magnet systems are typically designed as equal hung or slightly overhung voice coil configuration.

The typical prior art micro-transducer offers high sensitivity and low cost; however the following problems are generally observed:
The magnet system is non-linear, i.e. the force factor BI(x) depends significantly upon displacement x, causing distortion.
Due to the design of the circularly shaped magnet system (voice coil, center top plate, magnet, back plate, etc.), the force factor is, besides being non-linear, also quite low and asymmetrical, resulting in lower driving force and greater distortion.
The suspension system is non-linear and asymmetrical, i.e. the compliance C(x) varies with excursion, causing distortion.
The diaphragm has under-damped resonances, causing frequency response degradation (notch filter effects) and distortion within the audio band, resulting in a resonant distortion exhibiting very high values at certain frequencies.
The suspension compliance characteristics [m/Newton] of typical micro transducers do not fit well with small cabinet volumes, since the air compliance in the back enclosure will enlarge diaphragm and suspension break-up effects. Furthermore the suspension compliance is designed low enough to ensure that the speaker is fully stable (i.e. the diaphragm does not hit the yoke or front grill of the speaker) even when operating in free air. This will lead to a very high and undesirable resonance frequency of the total reproduction system when such micro-transducers are mounted in a housing with small back volumes. The typical prior art micro-transducer is characterised by functioning in all environments from free air to very small back volumes. This will lead to a very poor performance when they are mounted in small back volumes because the total compliance from the mechanical suspension and from the air in the back volume will be unnecessary low.

### Large Signal Compliance C(x) Characteristics Analysis—Prior Art

Various prior art micro-transducers (sizes, types) have been analysed in terms of compliance characteristics vs. diaphragm displacement; see FIGS. 2-6.

The selected micro-transducers represent the industry standard. From these measured characteristics it can be seen that the generally thin transparent plastic used as suspension is quite non-linear and asymmetrical, which causes both even and odd harmonic distortion.

The asymmetrical suspension in typical transducers is often introduced in order to compensate for the non-linear force factor, compensating for offset of the diaphragm. This unfortunately introduces distortion both from the suspension and the force factor. A second disadvantage of the thin transparent plastic is that the membrane breaks up, especially at high outputs with small back enclosures, causing significant distortion increase and sound pressure level (SPL) reduction (the suspension and diaphragm often have the same thickness and also often consist of the same material). A final negative effect of the suspension system is the reduction of effective diaphragm area.

From the analysis of different micro-transducers it is concluded that the compliance characteristics do not necessarily improve with size and depth, as such improvement is not gained by size. The limitations are within the transducer architecture/design itself.

FIG. 2 displays the non-linear mechanical suspension compliance characteristic of a 16 mm circular micro-transducer.

FIG. 3 displays the non-linear mechanical suspension compliance characteristic of a 20 mm circular micro-transducer.

FIG. 4 displays the non-linear mechanical suspension compliance characteristic of a 17*11*4 mm oval type micro-transducer.

FIG. 5 displays the non-linear mechanical suspension compliance characteristic of a 20*12*3.6 mm oval type micro-transducer.

FIG. 6 displays the non-linear mechanical suspension compliance characteristic of a 20*13*3.4 mm oval type micro-transducer.

### Force Factor BI(x) Characteristics Analysis—Prior Art

Typical micro-transducers have a low force factor, depending on manufacturer, design and physical size. FIGS. 7-11 displays the same micro-transducers shown in FIGS. 2-6, but now showing their force factor BI vs. voice coil excursion x, i.e. the function BI(x), in order to identify both the absolute force factor (affecting sensitivity) and the force factor contribution to distortion (the non-linearities).

As it appears from FIGS. 7-11, the large signal force factor characteristic of typical micro-transducers is quite low, non-symmetrical (around the y-axes) and non-linear (not constant). This results in a weak driving Lorentz force and in higher total harmonic distortion.

FIG. 7 displays force factor vs. displacement BI(x) for a 16 mm circular transducer.

FIG. 8 displays force factor vs. displacement BI(x) for a 20 mm circular transducer.

FIG. 9 displays force factor vs. displacement BI(x) for a 17*11*4 mm transducer.

FIG. 10 displays force factor vs. displacement BI(x) for a 20*12*3.6 mm transducer.

FIG. 11 displays force factor vs. displacement BI(x) for a 20*13 mm transducer.

### Membrane/suspension Break-up and Overall Distortion Characteristics—Prior Art

Another distortion element is membrane break-up, which is at best analysed by measuring actual distortion vs. frequency and output power. In FIGS. 12 and 13, typical prior art micro-transducers are measured in their environments, i.e. a housing with a back enclosure of 0.85 cubic centimetres (cc). Measurements are performed at a distance from the diaphragm of 10 cm and at 100 mW input power.

The overall distortion characteristic is very high, up to 40-60% at certain frequencies. Significant distortion exists above 1 kHz, i.e. in the frequency range where distortion products will be most audible.

The main reason for the resonant and frequency dependent distortion characteristics is the uncontrollable diaphragm and suspension, which breaks up at high frequencies, causing an unpleasant high frequency reproduction. The distortion is acceptable below 1 KHz in the less sensitive range. This is mainly due to small compliance from the small back enclosure combined with the 100 mW input, resulting in large internal sound pressure in the housing at low frequencies.

Above 1 KHz the amount of distortion is excessive, and because the human ear has the highest sensitivity in the 1 kHz to 4 kHz range, this is very undesirable and will lead to a harsh and unclear sound impression.

FIG. 12 displays distortion characteristics (THD) for an 18*13 mm regular micro-transducer transducer placed in 0.85 cc back volume, measured at a distance of 10 cm and with an input power of 100 mW.

FIG. 13 displays distortion characteristics (THD) for a 20*13 mm regular micro-transducer placed in 0.85 cc back volume, measured at a distance of 10 cm and with an input power of 100 mW.

### SUMMARY OF THE INVENTION

This invention defines a new principle for transducers named: “ICEpower SSL Micro-transducer”, where the abbreviation SSL stands for “Soft Suspension Long throw”.

The objective of the present invention is to overcome all or at least some of the disadvantages described above by providing a new micro-transducer architecture and method, offering significant improvements in overall distortion at high output levels throughout the audio range, extended bass reproduction in compact volumes, and an overall flat/non-resonant frequency response.

The SSL transducer technology according to the present invention has been developed primarily for small acoustic back enclosures, which makes it ideally suitable e.g. for mobile phones, which have little available space/volume for the acoustical system.

According to the invention there is provided a micro-transducer that will improve sound quality, attainable sound pressure level (SPL), and the bandwidth of the transducer and that will furthermore reduce non-linear distortion as compared to traditional micro-transducers or micro-speakers and acoustic systems for e.g. mobile phones.

According to the present invention the above and further objectives and advantages are obtained by a micro-transducer according to claim 1. Embodiments of the invention will be defined by the dependent claims and will be described in detail in the following.

According to the invention there is provided an electro-dynamic micro-transducer (micro-speaker) consisting of a very soft mechanical suspension, a non-circular center top plate, a non-circular flux gab, a non-circular voice coil, a back plate, a non-circular magnet, a non-circular diaphragm and soft suspension that may be optimised as two separately parts.

The present invention thus relates to a electro dynamic micro-transducer with a soft mechanical suspension having such a low stiffness [Newton/meter diaphragm movement] that it needs the stiffness provided from the air sealed in a small closed back volume upon which the transducer is provided in order to obtain a proper damping of diaphragm movement around the system resonance frequency and below. With the very soft mechanical suspension applied according to the invention, the voice coil will in practice hit the yoke of the magnet system when driven to high output sound pressure levels, if the micro-transducer is not mounted in a sealed back volume. The micro-transducer according to a preferred embodiment of the present invention, as seen from above, comprises a non-circular center top plate, a non-circular flux gab and a voice coil, the shape of which resembles that of the center top plate. The non-circular design of the micro-transducer ensures a very strong force factor and a large diaphragm area and thereby a powerful force exerted on the diaphragm combined with the soft suspension, which makes it suitable for small back volumes. The non-circular diaphragm and suspension can be optimised separately. The invention thus relates to a micro-transducer comprising a magnetic system comprising at least one magnet provided with pole pieces for forming an air gab in which a voice coil is movably provided, and furthermore comprising a diaphragm suspended in suspension means, allowing said movement of the voice coil in said air gab, where the compliance of said suspension means is greater than the compliance required in order to attain a specified frequency response or resonance frequency of the transducer, when the transducer is mounted on a device comprising a back volume, where the back volume is in fluid communication with said diaphragm.

According to a specific embodiment of the invention the micro-transducer comprises an additional outer non-circular magnet (also referred to as an SSL micro-transducer with two magnets). This transducer also comprises an additional outer, non-circular top plate on the additional outer magnet.

According to a further embodiment of the invention the back volume is provided with a vent or pipe (a vented box). The vent can thereby be tuned to provide a proper stiffness air damping.

Specifically the micro-transducer according to the invention is mounted in a small closed back volume. The back volume will typically be less than approximately 10 m³ and often less than 4 cm³.

Specifically ventilation holes or slits can be provided on the back plate or magnet.

The present invention also relates to a sound reproduction device comprising at least one micro-transducer according to the invention and where the device comprises a back volume, which on application will be in fluid communication with the diaphragm and/or suspension means of the transducer when the transducer is mounted on the device, thereby resulting in a desired frequency response or resonance frequency of the device.

Specifically said device could be a mobile phone, headphone, MP3-player, Bluetooth headset etc.

The present invention furthermore relates to a method of optimising the qualitative attributes, such as the non-linear distortion, frequency response and/or resonance frequency of a sound reproduction device, where the method comprises providing a micro-transducer with a compliance above the compliance required for optimising said frequency response and/or resonance frequency of the device and providing said transducer on said device so that the diaphragm and/or suspension means of the transducer is in fluid communication with an internal volume (back volume) of the device.

The method according to the invention would for instance be suitable for application in connection with mobile phones or headphones, but other audio applications may also be conceived.

### BRIEF DESCRIPTION OF THE DRAWINGS

The invention will be better understood with reference to the following detailed description of embodiments thereof together with the following figures:

FIG. 1: Prior Art, Typical Micro-Transducer.

FIGS. 2 and 3: The non-linear mechanical suspension compliance characteristic of circular micro-transducers.

FIGS. 4, 5 and 6: The non-linear mechanical suspension compliance characteristic of oval type micro-transducers.

FIGS. 7, 8, 9, 10 and 11: The force factor vs. displacement BI(x) for regular micro-transducers.

FIGS. 12 and 13: Distortion characteristics THD for oval shape micro-transducers placed in 0.85 cc back volume.

FIG. 14: SSL Transducer Prototype according to an embodiment of the invention.

FIG. 15: SSL Micro-transducer architecture according to an embodiment of the invention comprising one magnet.

FIGS. 16, 17 and 18: Physical internal SSL transducer construction of an embodiment of the invention comprising one magnet.

FIG. 19: An illustration of how the center top plate, flux gab and voice coil of the SSL transducer according to an embodiment of the invention could be shaped seen from above for both SSL micro-transducer with one magnet and two magnets.

FIG. 20: Different SSL diaphragm and SSL suspension assembly methods (side view) according to the invention.

FIG. 21: Cross-section view of an SSL micro-transducer with one magnet according to an embodiment of the invention.

FIG. 22: SSL Micro-transducer (with one magnet) according to an embodiment of the invention.

FIG. 23: Large signal mechanical suspension compliance characteristics of the SSL micro-transducer according to an embodiment of the invention.

FIG. 24: Resonance frequency versus diaphragm displacement for the SSL transducer according to an embodiment of the invention.

FIG. 25: Large signal force factor characteristics of the SSL transducer according to an embodiment of the invention.

FIG. 26: The PDF of an SSL transducer's diaphragm displacement.

FIG. 27: THD (total harmonic distortion) for prototype SSL micro-transducer according to an embodiment of the invention.

FIG. 28: SPL (sound pressure level) vs. frequency of the SSL micro-transducer according to an embodiment of the invention compared with two oval-shaped conventional micro-transducers.

FIG. 29: An SSL micro-transducer according to an embodiment of the invention and its closed back volume.

FIG. 30: An SSL micro-transducer according to an embodiment of the invention in a vented back volume.

FIG. 31: The physical architecture of the SSL micro-transducer according to an embodiment of the invention with two magnets (side view).

FIG. 32: The physical architecture of an SSL micro-transducer according to an embodiment of the invention with two magnets (top view).

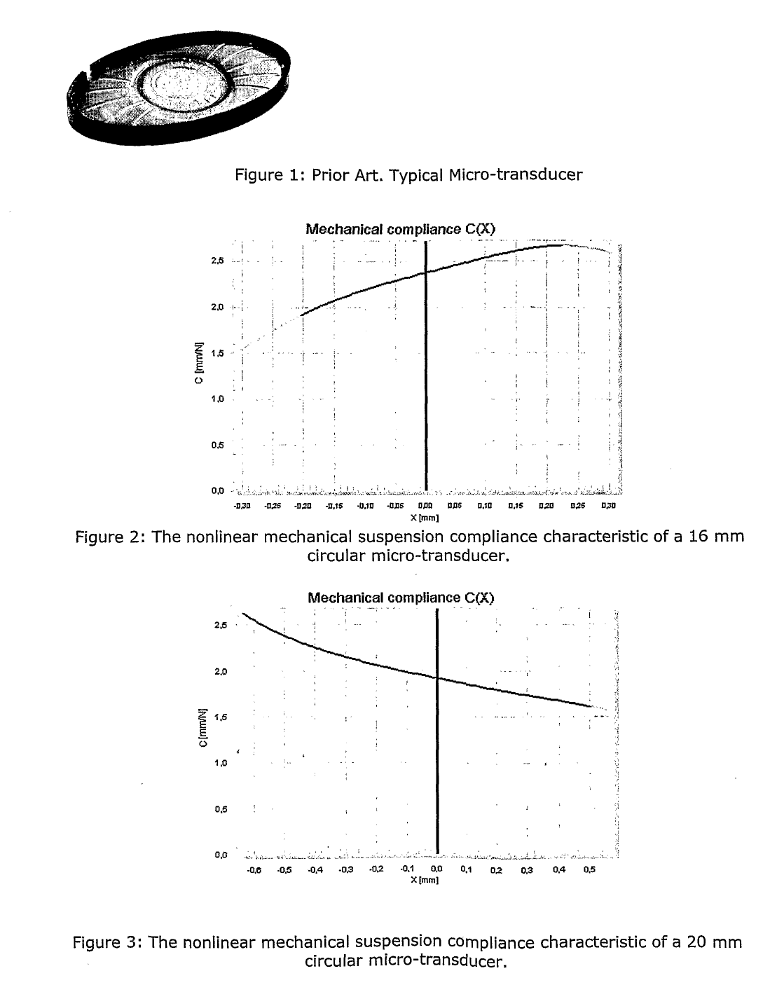

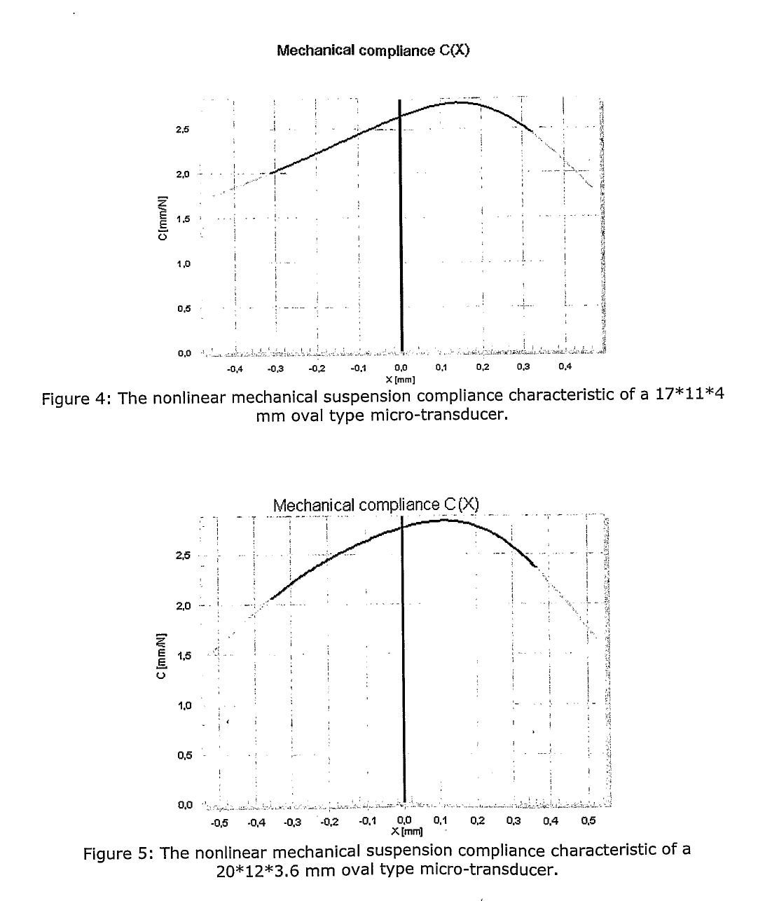

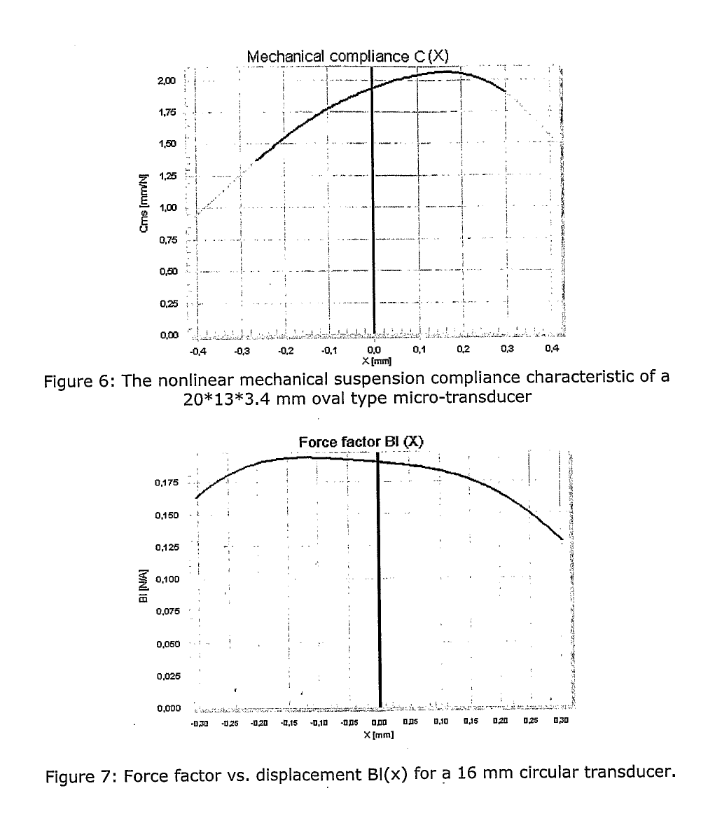

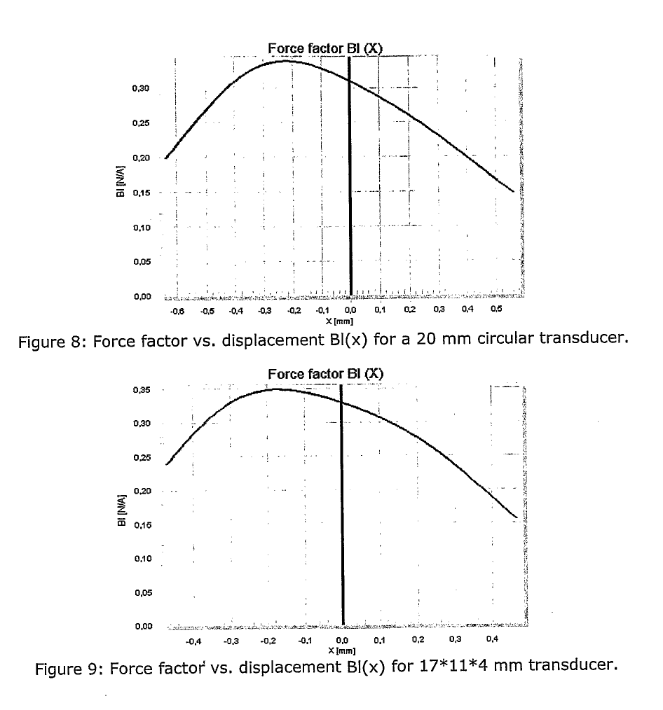

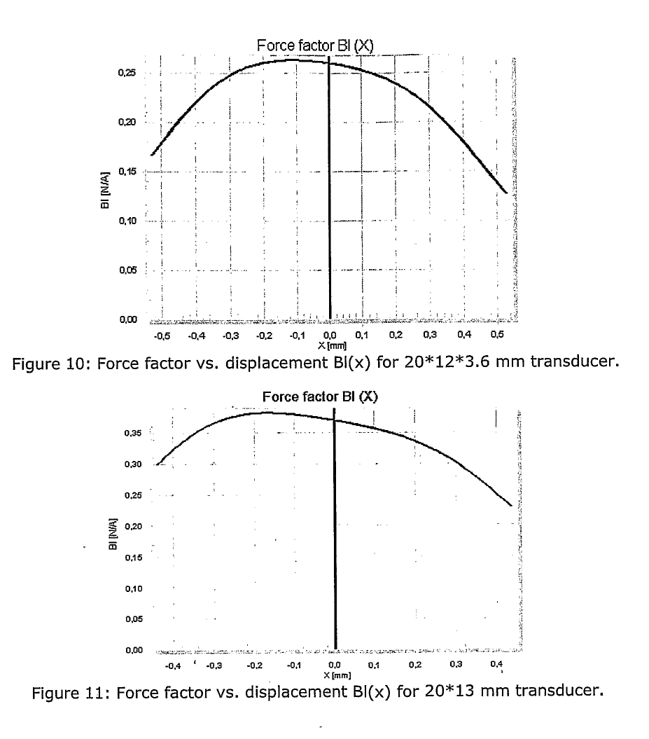

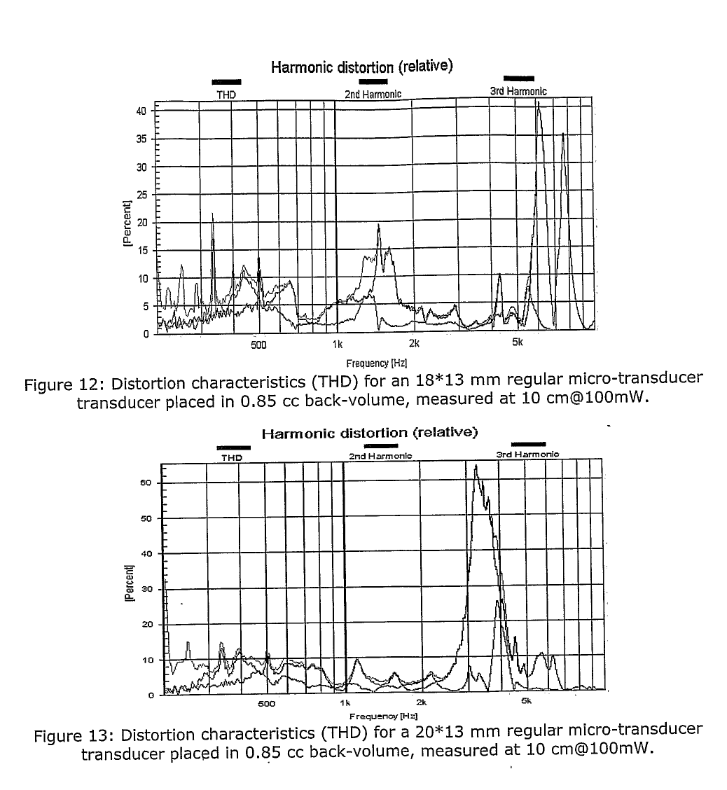

### DETAILED DESCRIPTION OF AN EMBODIMENT OF THE INVENTION

In the following a detailed description of embodiments of the micro-transducer according to the invention is given, but it is to be understood that the invention is not limited to the shown embodiments.

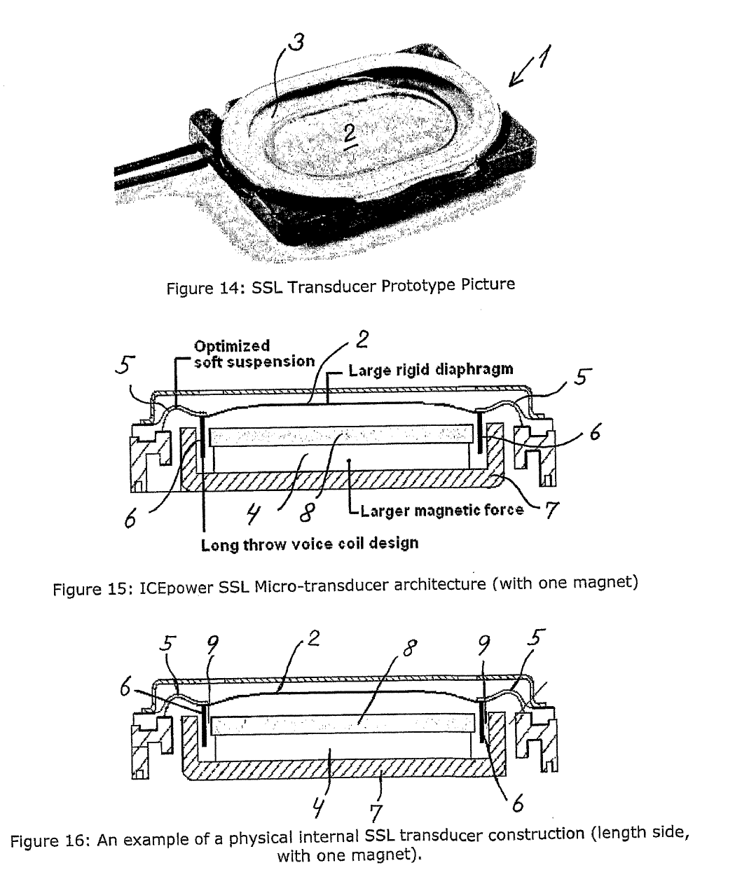

Referring to FIG. 14, there is shown an SSL Transducer Prototype according to the invention, basically comprising a large, rigid diaphragm portion 2 and an optimised soft suspension 3. The embodiment shown in FIG. 14 is of a substantially oval configuration, but other configurations could also be used, for instance dependent on the final application.

Referring to FIG. 15, there is shown an SSL Micro-transducer architecture according to an embodiment of the invention (with one magnet 4) with means for optimised soft suspension 5, a large rigid diaphragm 2, a long throw voice coil design 6 and the large magnetic force mechanism comprising the magnet 4 and the associated pole pieces 7, 8.

A description of how an SSL micro transducer's physical architecture could be designed can be seen on the FIGS. 16, 17, 18, and 19.

FIG. 16 shows an example of a physical internal SSL transducer construction according to an embodiment of the invention, shown as a partial longitudinal cross-sectional view and comprising one magnet 4.

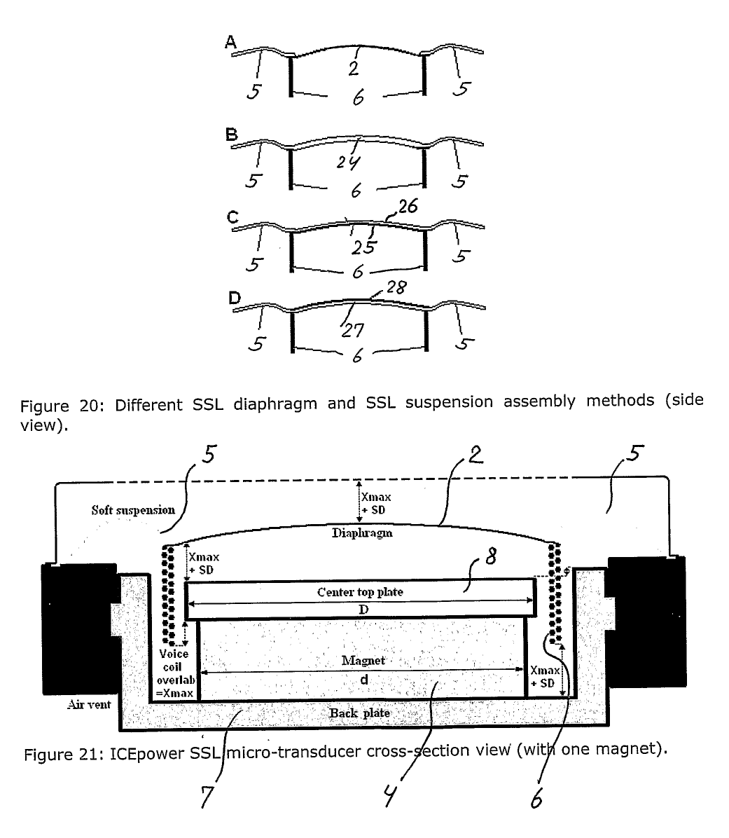

The suspension portion 5 is fastened to the diaphragm 2. The diaphragm 2 and suspension 5 could be made in one piece or made as two separate parts and then fixed together for instance with bonding adhesives, although other methods could also be applied (see FIG. 20). The suspension shape could for instance be like a half circle as shown in the figure or as two smaller half circles in series. The suspension part might be any kind of, but not limited to the materials described in the following in paragraph (3): “The suspension of the SSL micro-transducer”. The diaphragm might be any kind of, but not limited to the materials described in the following in paragraph (1): “The diaphragm of the SSL micro-transducer”.

The flux air gab 9 forms the region wherein the magnetic flux from the magnet is present. The magnetic flux extends between the center top plate 8 and the back plate 7, i.e. the yoke of the magnet system.

The magnet 4 is placed between the center top plate 8 and the back plate 7 (also referred to as the yoke). The magnet material might be any kind of, but not limited to the following materials: Neodymium, ferrite, boron, iron, or alloys of these.

The voice coil 6 is attached to the diaphragm 2 or the suspension portion 5. The voice coil material might be any kind of, but not limited to the following materials: Copper, aluminium, magnesium or alloys where one or more of these materials are used.

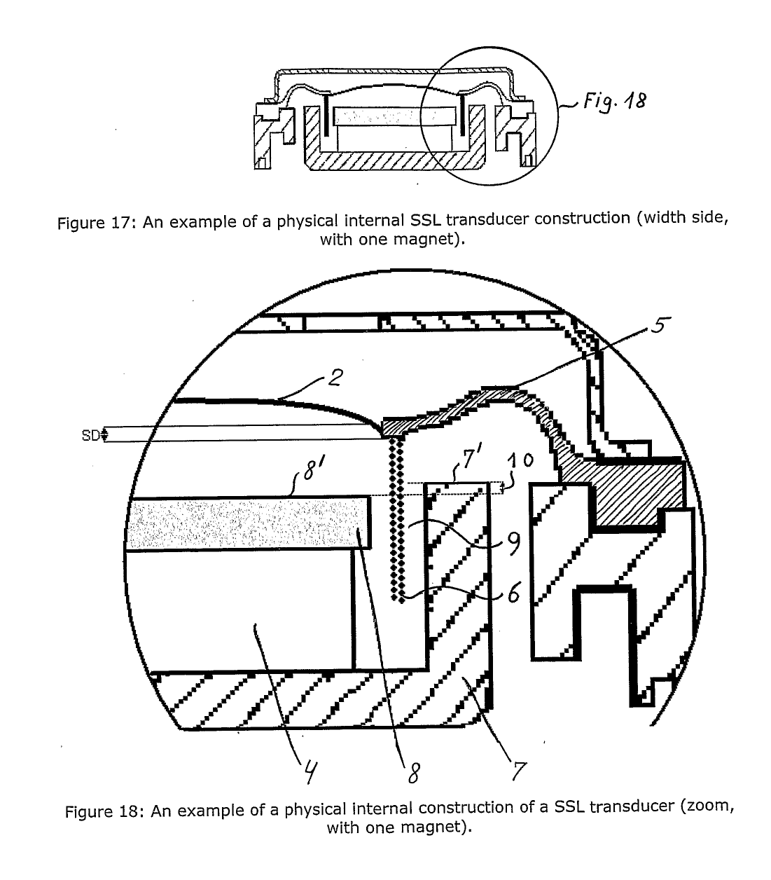

FIG. 17 shows an embodiment of a physical internal SSL transducer construction according to the invention (width side, with one magnet) and a detailed view of a part of this embodiment is shown in FIG. 18.

Referring to FIG. 18, it furthermore appears that the height of the top 8′ of the center top plate 8 (i.e. the vertical extension hereof in FIG. 18) and the height of the end 7′ of the back plate 7 can be different, although the invention is not limited to different heights of these two parts. The difference 10 of the height between the end of the back plate 7′ and the center top plate 8′ can be varied, thereby adjusting the magnetic flux density B and symmetry range in the flux gab (between the center top plate and the yoke).

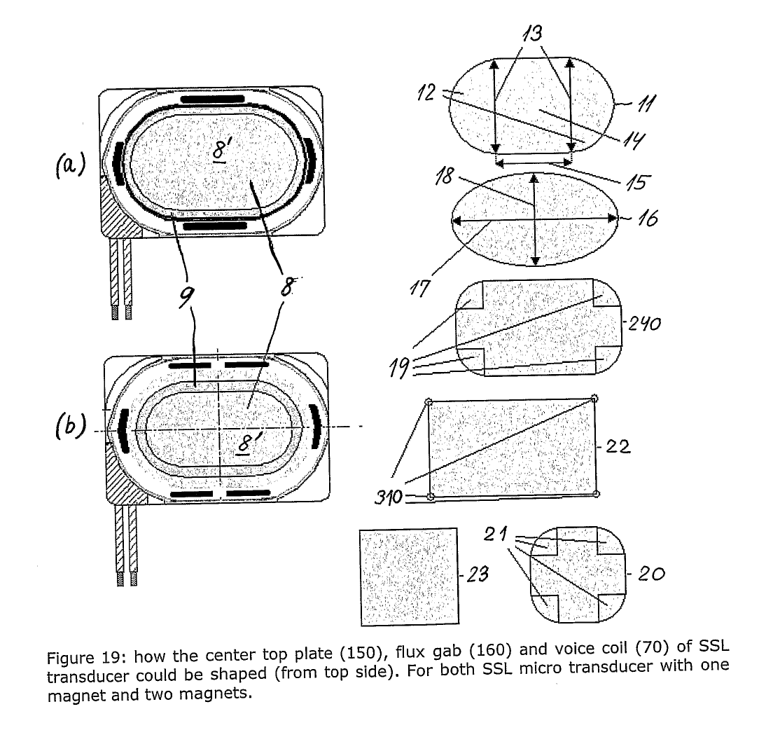

Referring to FIG. 19, there is shown how the center top plate 8 and flux gab 9 could be shaped (as seen from the top side) for both the SSL micro-transducer with one magnet (a) and two magnets (b).

On the left side of FIG. 19 a top view of the magnetic system can be seen (both with one (a) and two magnets (b)). The flux gab 9 and the center top plate 8 have been optimised to a non-circular form. The form of the center top plate 8 could be shaped as elongated/oval 11. The oval shape 11 consists of two half-circle areas 12 with a given diameter and a rectangular area 14 with the height 13 times the width 15. The shape of the center top plate 8 could also be elliptical 16, having a length 17 and a height 18 different from each other. The shape of the center top plate 8 could also be rectangular with shaped, e.g. rounded, corners 19 or quadrant 20 with shaped, e.g. rounded, corners 21. The size and shape of the corners could be any size and shape. The shape of the center top plate 8 could also be ideal rectangular 22, a substantially ideal rectangular, ideal quadrant 23 or a substantially ideal quadrant. Both the center top plate 8, the flux gab 9, the magnet 4 and voice coil 6 could have these shapes, but are not limited to any of the shapes mentioned above.

FIG. 20 shows different SSL diaphragm and SSL suspension assembly methods according to embodiments of the present invention (side view).

According to method A in FIG. 20, the suspension part 5 is attached on the upper side of the diaphragm 2. The diaphragm is bonded together with the voice coil 6. The diaphragm and suspension consist of different materials.

According to method B in FIG. 20, the suspension and diaphragm is made of the same material and in one piece, but the material is thickened in the diaphragm area 24 compared to the suspension part area 5. The thicker area 24 is attached to the voice coil 6.

According to method C in FIG. 20, the diaphragm 25 is attached to the voice coil 6. An additional diaphragm 26 consisting of the same material as the suspension 5 and made in one piece with the suspension portion 5 is attached on the top of the diaphragm 25, thus forming a sandwich structure of the two superimposed diaphragms 25 and 26.

According to method D in FIG. 20, the diaphragm 27 consists of the same material as the suspension 5 and is made in one piece with the suspension 5 and is attached to the voice coil 6. An additional diaphragm 28 is attached on top of the diaphragm 27, thus forming a complementary sandwich structure to the one described under method C above.

FIG. 21 displays the SSL micro-transducer architecture according to an embodiment of the invention in cross-sectional view (with one magnet). In one embodiment of the invention the transducer comprises the optimised soft suspension 5, the large stiff/rigid diaphragm 2, the long throw over hung voice coil 6 and the large magnetic force mechanism comprising the center top plate 8, the magnet 4, and the back plate 7.

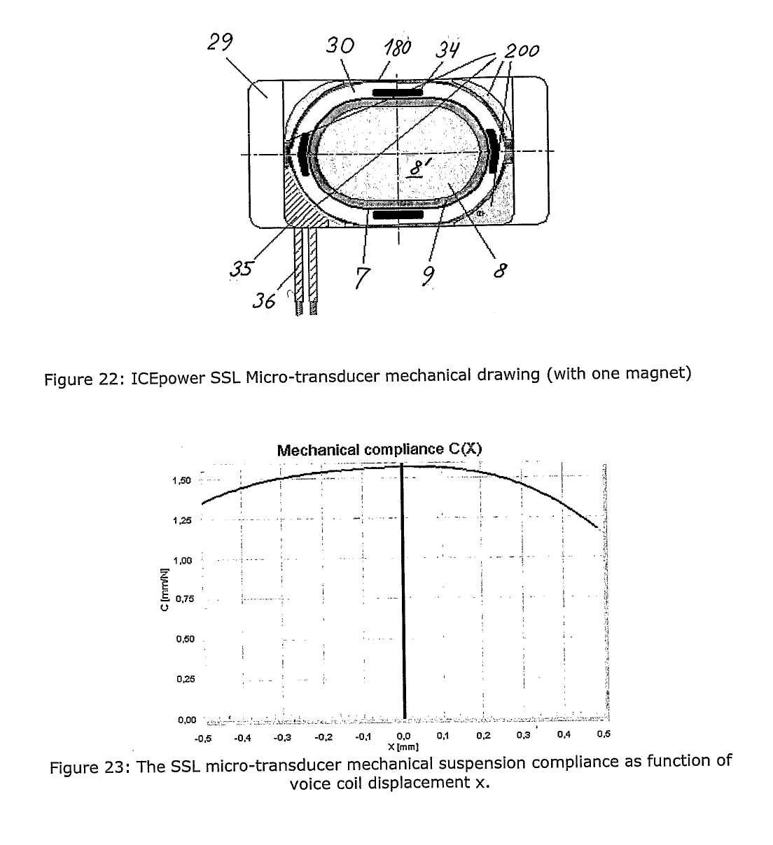

FIG. 22 shows a top view of the mechanical means principles of the SSL Micro-transducer (with one magnet) according to an embodiment of the invention.

The shape of the outer housing part 29 of the micro-transducer can be chosen as desired and the material of the outer housing part 29 of the micro-transducer can be any suitable material, for instance, but not limited to, the following materials: plastic, LCP, metal or magnetic materials.

The housing part 29, 30 encircles the magnetic system 7, 8 and 9. The inner housing part 30 may be of any suitable shape and made of any suitable material, for instance, but not limited to, plastic, LCP, metal, or magnet materials.

Four ventilation holes 34 in the inner housing part of the micro-transducer, housing 30 are shown in this example. The total number of ventilation holes could be four as shown in the Figure or another number of holes, as appropriate in the physical construction. The air from the back of the diaphragm flows forward and backwards through these ventilation holes 34 or through optional holes in the back plate or magnet.

The fastening material 35 for the micro-transducer wire could be glue, bonding adhesives or other similar materials. Inside the fastening material the connection wires 36 between the micro-transducer voice coil and outer connection wire are located.

The material of the outer connection wires 36 could be, but are not limited to, the materials: copper, aluminium, alloys. Any electrically conducting material could in fact be applied.

Below the center top plate 8 is provided the magnet (4 on FIG. 16) of the micro-transducer. The center top plate could be made of, but not limited to, iron or a compound consisting of one or more of the following materials: Fe, Si and Mn. It might be any electrically conducting material. The top plate as shown has a non-circular form. This form could be oval, elongated, rectangularly shaped, or elliptically shaped, but is not limited to these forms.

The flux air gab 9 is the region wherein the magnetic flux from the magnet extends. This flux air gab 9 has a non-circular form (from top view, see FIG. 19). This form could be oval, elongated, rectangularly shaped, or elliptically shaped, but is not limited to these forms. Between the center top plate 8 and the back plate the magnet is located With reference to FIG. 29 there is shown an SSL micro transducer according to the invention and its closed back volume.

The SSL micro transducer is either a one-magnet version or two-magnet version mounted in a closed air-sealed back volume 37.

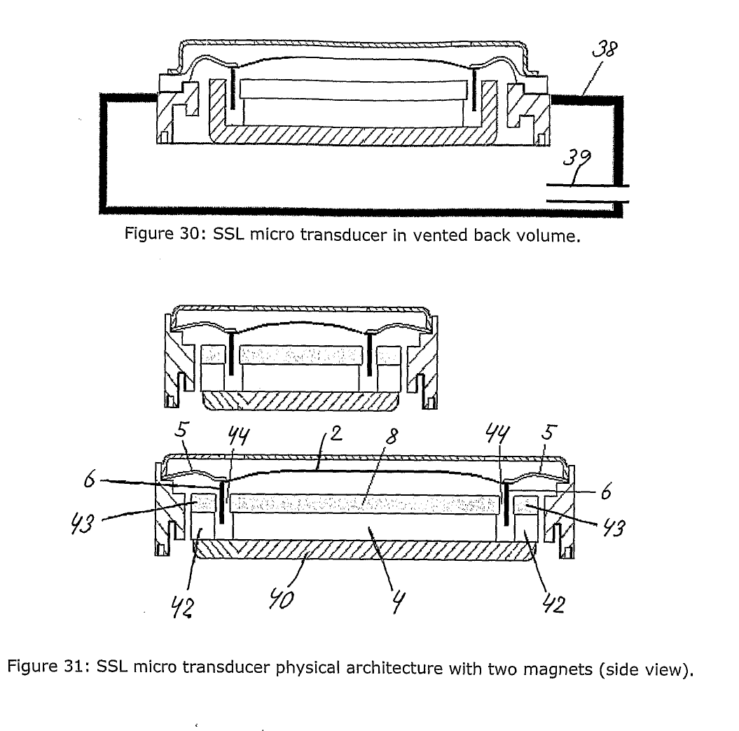

FIG. 30 shows the SSL micro-transducer in a vented back volume 38.

The SSL micro-transducer of either a one-magnet version or a two-magnet version is mounted in a vented back volume 38. In the vented back volume is mounted a vent 39, which could have any length and diameter and could be placed anywhere in the back volume, as long as it connects the inner part of the back volume 38 with the outside of the back volume. How large a portion of the vent 39 there is provided inside the vented back volume 38, and how large a portion of the vent 39 there is provided outside vented back volume 38, can be determined as desired. The vent 39 could be of any shape (both in cross shape and. longitudinally).

FIG. 31 shows an SSL micro-transducer physical architecture with two magnets (side view).

The back plate 40 is now both attached to the first, central magnet 4 and the outer magnet 42. The outer top plate 43 is attached to the outer magnet 42. The flux density gab 44 will now be located between the center top plate 8 and the outer top plate 43.

The outer magnet 42 is placed between the outer top plate 43 and the back plate 40 (also referred as the yoke). The outer magnet 42's material might be of any kind, for instance, but not limited to, the following materials: Neodymium, ferrite, boron, iron, or alloys of these.

The voice coil 6 is attached to the diaphragm 2 or the suspension part 5. The voice coil material might be of any kind, for instance, but not limited to, the following materials: Copper, aluminium, magnesium, or alloys where one or more of these materials are used.

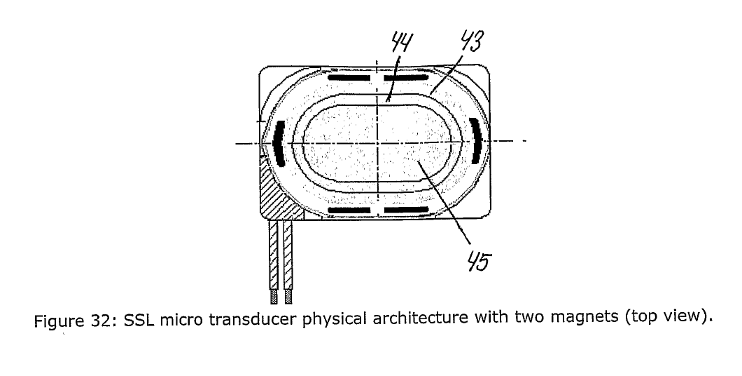

FIG. 32 shows an SSL micro-transducer physical architecture with two magnets (top view).

The outer top plate 43 can also have any kind of shape, for instance a non-circular shape.

The outer top plate 43 and back plate 40 could be made of iron or a compound consisting of one or more of the following materials: Fe, Si and Mn, but is not limited to these materials. It might be any electrical conducting material. The center top plate 8 and the air gab 44 could e.g. have a non-circular form (see FIG. 19 and the related text)

### 1) The Diaphragm of the SSL Micro-transducer

A picture of an SSL micro-transducer showing how a practical embodiment of the SSL diaphragm could look like can be seen in FIG. 14. The non-circular shaped diaphragm of the SSL micro-transducer is made of a thin stiff material which reduces the amount of diaphragm break-up, resulting in less distortion (this can be seen in the SSL transducer performance chapter). The non-circular (elliptical, oblong, rectangular, oval, or square, but not limited to these shapes) shaped diaphragm ensures a high effective diaphragm area for higher sensitivity of the transducer (This large diaphragm area, S_{d} is also important because the SSL micro-transducer uses the back cavity/volume as an air spring/air stiffness [Newton/meter]). The diaphragm can be made from thin aluminium, resulting in a very stiff diaphragm with very limited mass. Since aluminium has a good thermal conductivity and the voice coil and diaphragm can be thermally connected, the diaphragm can act effectively as a heat sink transferring heat away from the voice coil and magnetic system, increasing the long-term power handling and sensitivity.

The material of the non-circular shaped SSL diaphragm can also consist of beryllium, titanium, magnesium, Silicon carbide (SiC), Aluminum/Silicon carbide, PI: Polyimide, PET: poly ethylene terephthalate, PEN: poly ethylenenaphthalate, PE: poly ethylene PPS: poly phenylen sulphide PEN: polyethylenenaphthalate, or alloys of any of these materials, or other materials that have a low density and a high Young's modulus constant, in order to provide a large light-weight diaphragm not exhibiting break-up resonances. Furthermore it can be seen on FIG. 18 that the diaphragm can have a bent shape to ensure a safe distance (SD on FIG. 18) and to minimise break-ups in the diaphragm. Since there is no voice coil former, this shape ensures that the diaphragm does not hit the center top plate when the voice coil and diaphragm move downwards towards the back plate (same as yoke)

### 2) The Motor System of the SSL Micro-transducer

A further embodiment of the invention comprises the application of an increased magnet 4 diameter as shown in FIGS. 16 and 31 (4), resulting in the maximum magnetic system handling higher flux density and obtaining a greater force factor, enabling the generation of increased sound pressure level (SPL). Besides increased magnet diameter, the whole magnetic system is according to the invention optimised to a non-circular shape, which results in larger BI-product and effective diaphragm area, leading to an improved bass response. The SSL transducer's large-diameter non-circularly shaped magnetic system (back plate, magnet, center top plate, and of course the magnetic flux air gab) is remarkably different to the traditional micro-transducers, which have a circular magnetic system (back plate, magnet, center top plate and of course the magnetic flux air gab). The SSL transducers according to the invention comprising an optimised non-circular center top plate 8 and flux gab 9 or 44 can be seen from FIGS. 16, 19, 22, 31 and 32. The magnet 4 could have a shape closely resembling that of the center top plate 8.

The SSL transducer according to the invention has a large non-circularly shaped magnet that can have the same shape as the center top plate 8 on FIG. 19, but which is not limited to these shapes. The magnetic force is increased by having a larger cross-sectional area (from top view) of the magnet, resulting in a higher sound pressure level (SPL). This large magnet together with the back plate ensures a large static B-field in the flux gap. The large voice coil of the SSL micro-transducer ensures a long length of wire in the strong static flux gap, leading to a high force factor (A large diaphragm area combined with a large diaphragm movement will lead to a large internal pressure in the back volume, combined with a large moving mass which will require a strong actuator/Lorentz driving force. The SSL micro-transducer has therefore a strong force factor). The overhung voice coil configuration leads to a strong and very linear force factor, thereby reducing the distortion. This can be seen from FIG. 25 in the SSL transducer performance chapter.

The force factor acting on the voice coil is furthermore linearised by the introduction of center top plate overlaps (FIG. 21: center top plate 8 has the same or larger diameter (D) as the magnet (d), resulting in lower levels of THD and a very symmetric force factor around the rest position).

Besides increased magnet diameter, the whole magnetic system is optimised to a non-circular shape, which results in a larger BI-product and effective diaphragm area, leading to an improved bass response. The SSL transducer's large-diameter non-circularly shaped magnetic system (magnet 4, center top plate 8, voice coil 6 and of course the magnetic flux air gap 9 or 44) is remarkably different from the traditional micro-transducer, which has a circular magnetic system.

It is generally known that the air ventilation can be improved by introducing a hole in the back plate below the voice coil. Cooling of the voice coil will increase the sensitivity of the transducer and increase the long-term RMS power handling. The voice coil and diaphragm can be thermally connected so that the diaphragm acts as an effective heat sink, transferring heat away from the voice coil and the magnetic system.

### 3) The Suspension of the SSL Micro-transducer

The SSL micro-transducer is characterised by the diaphragm and suspension implemented as two fully optimised parts. Either the diaphragm and suspension can consist of different materials and are attached to each other by suitable means, or the suspension and diaphragm can be made from the same material, but then the diaphragm must be made more stiff, for example by thickening the material, or be coated with a more stiff material like the materials of the SSL diaphragm mentioned in the paragraph: (1) The diaphragm of the SSL micro-transducer), a stiff diaphragm and a soft suspension. The material of the mechanical suspension can be made out of materials like: rubber, rubber compounds, butyl rubber, silicone, santoprene, acrylonitrile rubber, PI: Polyimide, PET: poly ethylene terephthalate, PE30, PEN: poly ethylenenaphthalate, PE: poly ethylene, Arnitel, DYNAFLEX, KRATON, silicone, TPE: Thermoplastic elastomer compound, TPU: Thermoplastic Polyurethane Elastomer, other elastomer compounds, but is not limited to these materials.

The mechanical moving mass, the mechanical resistance of total-driver losses, and the mechanical suspension stiffness can be described as a 2nd order oscillating mechanical system with one degree of freedom. The resonance frequency f₀ of such a system is well known as:

$${f}_{0} = \frac{1}{2 \cdot π} \sqrt{\frac{K}{{M}_{ms}}}$$

where K, [Newton/meter] is the total stiffness of the system, including both the mechanical stiffness, Kₘₛ from the transducer (mainly from the suspension) and the acoustical stiffness, kₐ from the closed back volume. Mₘₛ is the total effective moving mass. (the stiffness [Newton/meter] is the reciprocal of the compliance [meter/Newton])

The system resonance frequency (the transducer and its cabinet/back volume/closed box) can thus be tuned by modifying the stiffness of the system. It is generally known that the sensitivity of a transducer decreases below its resonance frequency (2^{nd} order roll-off). This means that the general low-frequency sensitivity of the transducer can be increased by lowering the transducer resonance frequency, i.e. through lowering of the mechanical suspension stiffness. The cost of this modification is that the diaphragm excursion will become larger for low frequencies, which could potentially destroy the transducer as the voice coil hits the back plate (same as yoke). Below the resonance frequency it becomes a trade-off between sensitivity and too much acoustical output power when using a full-range signal.

FIG. 29 shows the SSL micro transducer and its closed back volume 37. Outside the closed back volume (reference numeral 50) is the atmospheric pressure p₀(t). When the diaphragm is in rest position (no displacement), the pressure inside the back volume is also atmospheric, p₀(t). When the diaphragm moves, the volume will also change (the displacement times the moved area), and the pressure inside the back volume 51 will thereby also change. A pressure acting on a given area results in a force, which in this case exerts on the diaphragm of the SSL micro transducer. It is generally known that the linear formula of the acoustical stiffness of a closed back volume is defined as:

$$\begin{matrix}{k}_{a} = \frac{{f}_{d}}{{u}_{d}} \\ = \frac{{S}_{d}^{2} \cdot {ρ}_{0} \cdot {c}_{0}^{2}}{{V}_{k}}\end{matrix}$$

where kₐ is the acoustical stiffness of a closed back volume, S_{d} is diaphragm area, p₀ is the density of air, c₀ is the speed of sound Vₖ is the volume of the back volume, f_{d} is the force from the internal pressure exerted on the diaphragm and u_{d} is the diaphragm velocity.

The air inside the small back volume will thereby act as a suspension with a certain stiffness (Newton per meter of diaphragm movement). If the back volume is quite small, the stiffness from the compressed air will be quite high and the mechanical stiffness of the suspension can therefore be lowered quite substantially. The cost of this low mechanical suspension is that the micro-transducer no longer will be stable at maximum output in free air (This is the case for the SSL micro-transducer).

As the acoustical stiffness provided by the air in the small closed volume is much larger than the acoustical stiffness as seen from the transducer in an infinite baffle or free air, the mechanical suspension stiffness of the transducer may be reduced significantly, lowering the overall stiffness of the system and thereby the resonance frequency of the system. This provides for a lower resonance frequency and thus higher sensitivity in the low frequency region. Along with the reduction of mechanical stiffness (due to the softer suspension), the mechanical damping is also reduced, but as it is designed to be used only in small cabinets where the air stiffness and damping are significant factors, the free air properties become less relevant.

For a general-purpose micro-transducer the tuning of the mechanical suspension stiffness is typically based on a worst-case scenario, i.e. usage in an infinite baffle or even in free air, and when used with a small enclosure the resonance frequency increases significantly, thus decreasing the level of low frequencies. For the SSL micro-transducer according to the invention, the stiffness of the mechanical suspension is tuned to make it behave well in small enclosures (It needs the stiffness from the back volume air because its mechanical suspension stiffness is too low for the transducer to function in free air or large baffle at high output) without much regard to the micro-transducers free air properties.

### SSL Transducer Performance

The overall performance gains as compared with prior art micro-transducers are illustrated by measurements on a 20×13×4.7 mm SSL micro-transducer according to the invention. The SSL micro-transducer could be of any size.

### SSL Compliance C(x) Characteristics

The measured compliance characteristic of an SSL transducer prototype can be seen in FIG. 23. This Figure displays an SSL transducer's mechanical compliance in free air as function of voice coil displacement x.

The compliance C(x) characteristic of an SSL transducer is shown to be quite linear. It is generally known that the resonance frequency is defined as:

$${f}_{s} = \frac{1}{2 \cdot π \cdot \sqrt{{M}_{ms} \cdot C ( x )}}$$

where Mₘₛ, the total mechanical moving mass, is considered to be constant. This means that when the mechanical suspension compliance is almost linear like in the SSL transducer, and the resonance frequency will also be quite linear (A non-linear compliance like in the conventional micro-transducers will cause a non-linear resonance frequency, varying much as a function of the diaphragm excursion).

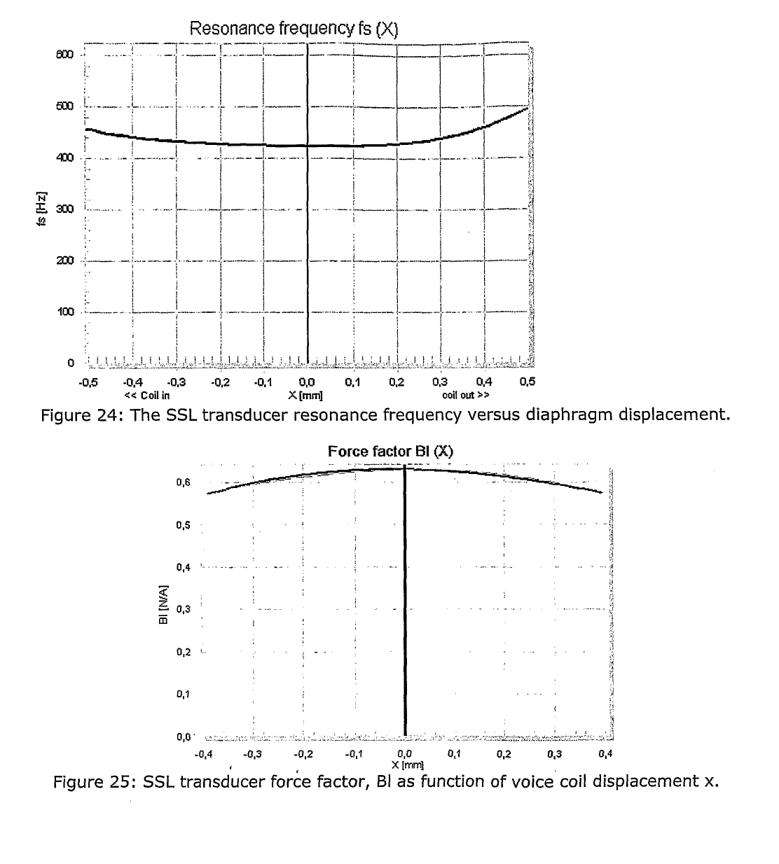

FIG. 24 shows the measured large-signal resonance frequency of the SSL transducer. From this graph it can be seen that the relationship between the resonance frequency and the diaphragm displacement is quite linear and limited, which is desirable to obtain a good sound quality at higher output levels.

Even more important, the SSL transducer has a much more symmetrical mechanical suspension compliance compared with other industry standard micro-transducers.

### SSL Force Factor BI(x) Characteristics

FIG. 25 shows the measured force factor as function of the voice coil displacement of a 20*13*4.7 mm SSL micro-transducer according to the invention mounted in a 0.9 cc back enclosure. It can be seen from the figure that the force factor is very high, linear and symmetrical. This creates a strong driving force, especially needed in the low frequency range in small back enclosures, which is normally seen in mobile phone environments.

The linear force factor constant B1(0) is typically ranging from medium to very strong for the SSL transducers (0.62 N/A on FIG. 25). Typical micro-transducers normally have a low force factor, depending on manufacturer, design and physical size. This results in a weaker driving Lorentz force and in higher total harmonic distortion.

The SSL micro transducer's symmetrical and linear force factor and suspension ensures a symmetrical movement of the stiff diaphragm with no DC offset, supporting high linearity. An asymmetrical diaphragm movement will cause distortion and non-efficient transducer design.

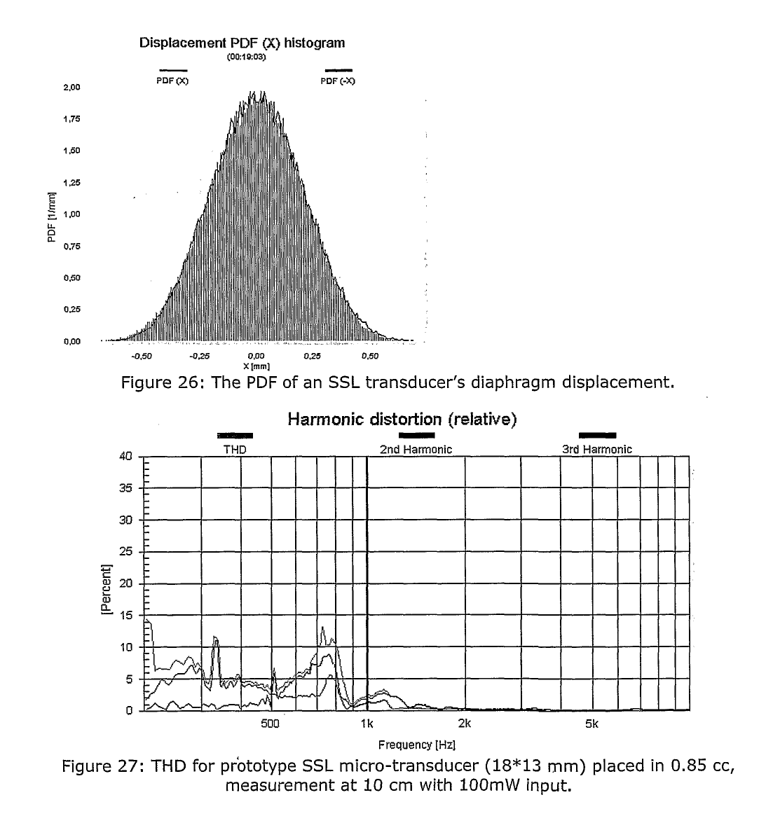

FIG. 26 shows the probability density function (PDF) of the evaluated SSL transducers diaphragm displacement x. From the figure it can be seen that the diaphragm displacement of the SSL transducer over a given time period moves very smoothly and symmetrically around x=0 mm.

### SSL Break-up Characteristics and Overall Performance

By a combination of these individual methodologies and embodiments of the invention, the amount of distortion is significantly reduced compared to traditional micro-transducer architectures.

A comparison THD between the SSL transducer and typical micro-transducers measured earlier has been made under identical back-volume implementation and driving with the same input power. The overall distortion characteristics are illustrated in FIG. 27.

FIG. 27 displays the THD for a prototype SSL micro-transducer (18*13 mm) placed in 0.85 cc, measurement at 10 cm with 100 mW input.

It is seen that the THD is very low, despite the small back enclosure. Above 2 kHz, distortion is less than 1%, and in the 800 Hz-2 kHz region distortion is less than 3%. This is 10-20 times lower than the typical micro-transducer architectures evaluated earlier.

Clearly from FIG. 27, there is no sign of break-up distortion of the diaphragm.

### SSL Technology Sensitivity and Power Handling

Since the SSL transducer has been designed with a strong force factor due to the non-circularly shaped magnetic system and voice coil configuration, the strong force factor affects the sensitivity positively.

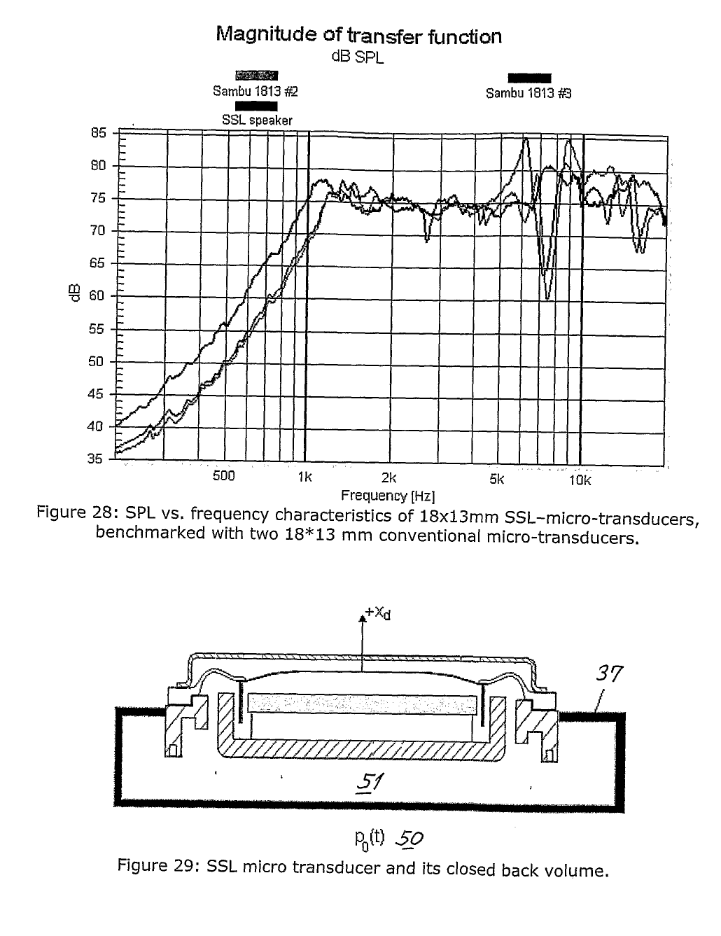

FIG. 28 shows a plot of sound pressure level (SPL) vs. frequency for an example SSL transducer, benchmarked with two other 18×3 mm micro-transducers. All three transducers have been placed in a 0.85 cc back enclosure and measured at a distance of 10 cm, using 100 mW input power.

From FIG. 28 it is obvious that the SSL technology provides improves overall frequency response and furthermore extends bass response compared to traditional micro-transducers.

A further advantage of the SSL transducer, when using e.g. aluminium as membrane material for low weight, is that the diaphragm itself will function as an extended heat sink, providing significant surface area to distribution voice coil generated heat. Hence, overall power handling of the SSL micro-transducer is improved.

1. A micro-transducer for obtaining a specified frequency response or resonance frequency, comprising:
a voice coil.
a magnetic system comprising at least one magnet provided with pole pieces for forming an air gap
a diaphragm, and
a suspension for said diaphragm and for said voice coil by which movement of said voice coil in said air gap is allowed, said suspension providing a mechanical compliance for movement of said diaphragm that is greater than a compliance required in order to attain said specified frequency response or resonance frequency; and
a back volume of less than 10 cm³, provided in fluid communication with at least one of the diaphragm and the suspension, said back volume providing a volume compliance for movement of said diaphragm;
whereby said diaphragm has a resulting compliance which is a combination of the mechanical compliance and the volume compliance so that the specified frequency or resonance frequency for the micro-transducer system is attained.

2. A micro-transducer according to claim 1, characterized in that said diaphragm is non-circular.

3. A micro-transducer according to claim 2, characterized in that said magnet, said pole pieces, said air gap and said voice coil are similarly, non-circular shaped.

4. A micro-transducer according to claim 1, characterized in that said diaphragm and said suspension are formed as one piece.

5. A micro-transducer according to claim 1, characterized in that said diaphragm is formed as a sandwich structure.

6. A micro-transducer according to claim 1, characterized in that the micro-transducer comprises an additional outer non-circular magnet and an additional outer non-circular top plate.

7. A micro-transducer according to claim 1, wherein ventilation holes are provided on one of the back enclosure or the magnet.

8. A sound reproduction device for obtaining a specified frequency response or resonance frequency, comprising:
at least one micro-transducer comprising
a voice coil,
a magnetic system comprising at least one magnet provided with pole pieces for forming an air gap,
a diaphragm, and
a suspension for said diaphragm and for said voice coil by which movement of said voice coil in said air gap is allowed, said suspension providing a mechanical compliance for movement of said diaphragm that is greater than a compliance required in order to attain said specified frequency response or resonance frequency; and
a back enclosure in which said micro-transducer is mounted so that a back volume of less than 10 cm³ is provided in fluid communication with at least one of the diaphragm and the suspension, said back volume providing a volume compliance for movement of said diaphragm;
whereby said diaphragm has a resulting compliance which is a combination of the mechanical compliance and the volume compliance thereby resulting in the specified frequency response or resonance frequency of the device.

9. A device according to claim 8, where the device is one of a mobile phone or a headphone.

10. A device according to claim 8, wherein said back volume is provided with at least one vent.

11. A device according to claim 8, where said back volume is in the range of less than 4 cm³.

12. A method of optimizing a qualitative attribute, such as at least one of a non-linear distortion, a frequency response and a resonance frequency, of a sound reproduction device, where the method comprises the steps of:
providing a micro-transducer for the sound device with a mechanical compliance above the compliance required for optimizing the qualitative attribute of the device; and
mounting said micro-transducer on said sound device so that at least one of a diaphragm or a suspension of the micro-transducer is in fluid communication with an internal volume of less than 10 cm³ of the device, the internal volume providing a volume compliance for movement of said diaphragm whereby the diaphragm has a resulting compliance which is a combination of the mechanical compliance and the volume compliance thereby resulting in the optimized attribute of the sound device.

13. The method according to claim 12, where said device is one of a mobile phone, a headphone, a portable device, an MP3-player, or Bluetooth capable.

14. (canceled)

15. A micro-transducer according to claim 1, where said back volume is in the range of less than 4 cm³.

16. A micro-transducer according to claim 15, where said back volume is in the range of less than 1.5 cm³.

17. A device according to claim 11, where said back volume is in the range of less than 1.5 cm³.

18. A method according to claim 12, where said back volume is in the range of less than 4 cm³.

19. A method according to claim 18, where said back volume is in the range of less than 1.5 cm³.

20. A device according to claim 8, characterized in that said diaphragm, said magnet, said pole pieces, said air gap and said voice coil are all similarly, non-circular shaped.

21. A micro-transducer according to claim 1, wherein said pole pieces of said magnet are a center top plate having a center top plate height and a back plate surrounding said center top plate and having a back plate height which is greater than the center top plate height and which can be varied to vary a magnetic flux density B and a symmetry range in the flux gap.

22. A device according to claim 8, wherein said pole pieces of said at least one magnet are a center top plate having a center top plate height and a back plate surrounding said center top plate and having a back plate height which is greater than the center top plate height and which can be varied to vary a magnetic flux density B and a symmetry range in the flux gap.

23. A method according to claim 12, wherein the micro-transducer has a magnet with a center top plate having a center top plate height and a back plate surrounding said center top plate and having a back plate height which is greater than the center top plate height; and further including the step of varying the height of the back plate to vary a magnetic flux density B and a symmetry range in a flux gap between the center top plate and the back plate.
